(19) United States
(12) Patent Application Publication
(10) Pub. No.: US 2010/0247819 A1
(43) Pub. Date: Sep. 30, 2010

(54) THERMAL TRANSFER SHEET

(75) Inventors: Shinichi TERAMAE, Minami-ashigara-shi (JP); Naotsugu MURO, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/749,174

(22) Filed: Mar. 29, 2010

(30) Foreign Application Priority Data
Mar. 30, 2009 (JP) 2009-081138

(51) Int. Cl. B41M 5/395; B41M 5/382

(52) U.S. Cl. 428/32.86; 428/32.6

(57) ABSTRACT

A thermal transfer sheet having a dye layer that contains a thermotransferable dye and a binder on a substrate film, wherein the dye layer contains a dye of the following formula (1), and at least 50% by mass of the binder in the dye layer is a carboxylic acid-modified polyvinyl acetal resin:

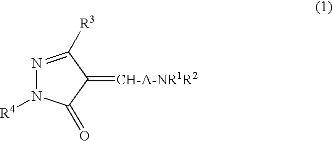

wherein A represents a phenylene group; R¹ and R² represent a hydrogen atom, an alkyl group, or an aryl group; R³ represents an amino group, an alkoxy group, or an aryloxy group; R⁴ represents an alkyl group, or an aryl group.

### CROSS-REFERENCE TO RELATED APPLICATIONS

The present application claims the benefit of priority from Japanese Patent Application No. 2009-081138, filed on Mar. 30, 2009, the contents of which are herein incorporated by reference in their entirety.

### BACKGROUND OF THE INVENTION

1. Field of the Invention

The present invention relates to a thermal transfer sheet, and in particular to a thermal transfer sheet excellent in low-temperature runnability and maximum transfer density.

2. Description of the Related Art

Heretofore, various thermal transfer recording methods are known. Above all, a dye diffusion transfer recording system is specifically noted as a process capable of producing color hard copies of which the image quality is the nearest to that of silver salt photographs.

In the dye diffusion transfer recording system, a dye-containing thermal transfer sheet (generally referred to as “ink sheet”) and a thermal transfer image-receiving sheet (hereinafter referred to as “image-receiving sheet”) are put one upon another, and the thermal transfer sheet is heated with a thermal head or the like from which the heat generation is controlled by electric signals given thereto, whereby the dye in the thermal transfer sheet is transferred onto the thermal transfer image-receiving sheet for image information recording thereon. In this, three colors of cyan, magenta and yellow are recorded as superimposed, thereby giving a color image having a continuously changing color density in a mode of transfer recording.

The dye diffusion transfer recording system does not require chemicals like those for silver salt photographs, and therefore has the advantage of downsizing of printer and is used as an in-store terminal.

One technical problem with the dye diffusion transfer recording system is how to increase the image density. For producing high-density images, JP-A 2004-230878 describes a method of adding a specific dye to the thermal transfer sheet, and JP-A 2006-69196 describes a method of adding a specific binder thereto.

With diversified needs these days, in-store terminals may be often installed not only inside stores but also outside in the environment where temperature/humidity control is impossible, for example, in a low-temperature environment in winter.

Even in a low-temperature environment, thermal transfer sheets must smoothly run through the device with no trouble to give prints (this may be referred to as “low-temperature runnability” in this description); however, the thermal transfer sheet produced by the use of a specific dye described in JP-A 2004-230878 has a problem in that its low-temperature runnability specifically worsens in a low-temperature environment.

### SUMMARY OF THE INVENTION

An object of the invention is to provide a thermal transfer sheet having good low-temperature runnability and having a high maximum transfer density.

The present inventors have assiduously studied to know why the low-temperature runnability of thermal transfer sheets may worsen, and, as a result, have found that one reason is because, when the thermal transfer sheet that contains a dye of the following formula (1) is stored in a low-temperature low-humidity environment for a long period of time, the dye precipitates out on the surface of the dye layer of the sheet. Consequently, the inventors have further studied and at last have found that when a carboxylic acid-modified polyvinyl acetal resin is added to the dye layer of the thermal transfer sheet, then the property of the dye can be relaxed, and have reached the present invention.

Specifically, the inventors have found that, when a dye of the following formula (1) and a carboxylic acid-modified polyvinyl acetal resin are, as combined, added to the dye layer of a thermal transfer sheet, then the above-mentioned problems can be solved.

[1] A thermal transfer sheet having a dye layer that contains a thermotransferable dye and a binder on one side of a substrate film, wherein the dye layer contains at least one dye of the following formula (1), and at least 50% by mass of the binder in the dye layer is a carboxylic acid-modified polyvinyl acetal resin:

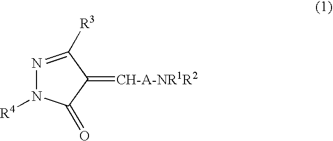

wherein A represents a substituted or unsubstituted phenylene group; R¹ and R² each independently represent a hydrogen atom, a substituted or unsubstituted alkyl group, or a substituted or unsubstituted aryl group; R³ represents a substituted or unsubstituted amino group, a substituted or unsubstituted alkoxy group, or a substituted or unsubstituted aryloxy group; R⁴ represents a substituted or unsubstituted alkyl group, or a substituted or unsubstituted aryl group.

[2] The thermal transfer sheet of [1], wherein at least 50 mol % of the acetal structure in the carboxylic acid-modified polyvinyl acetal resin is an acetacetal structure.

[3] The thermal transfer sheet of [1] or [2], wherein the ratio by mass of the dye to the binder (dye/binder) is from 1.4 to 2.5.

According to the constitution of the invention, there can be provided a thermal transfer sheet substantially free from a problem in recording of image information through transfer of the dye in the thermal transfer sheet onto a thermal transfer image-receiving sheet in a printer system even when exposed to a low-temperature environment.

### BEST MODE FOR CARRYING OUT THE INVENTION

The invention is described in detail hereinunder. In this description, the numerical range expressed by the wording “a number to another number” means the range that falls between the former number indicating the lowermost limit of the range and the latter number indicating the uppermost limit thereof.

### [Thermal Transfer Sheet]

The thermal transfer sheet of the invention has a dye layer (hereinafter this may be referred to as “thermal transfer layer”) that contains a thermotransferable dye and a binder on one side of a substrate film, wherein the dye layer contains at least one dye of the following formula (1), and at least 50% by mass of the binder in the dye layer is a carboxylic acid-modified polyvinyl acetal resin.

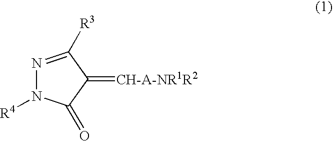

wherein A represents a substituted or unsubstituted phenylene group; R¹ and R² each independently represent a hydrogen atom, a substituted or unsubstituted alkyl group, or a substituted or unsubstituted aryl group; R³ represents a substituted or unsubstituted amino group, a substituted or unsubstituted alkoxy group, or a substituted or unsubstituted aryloxy group; R⁴ represents a substituted or unsubstituted alkyl group, or a substituted or unsubstituted aryl group.

### <Constitution of Thermal Transfer Sheet>

The thermal transfer sheet is put on a thermal transfer image-receiving sheet in thermal transfer image formation thereon, and these are heated with a thermal printer head or the like from the side of the thermal transfer sheet to thereby transfer the dye from the thermal transfer sheet onto the thermal transfer image-receiving sheet.

Preferably, the thermal transfer sheet of the invention has a heat-resistant lubricant layer on the other side of the substrate film not having the dye layer. An easy-adhesion layer (primer layer) may be provided between the substrate film and the dye layer or between the substrate film and the heat-resistant lubricant layer.

### <Substrate Film>

Not specifically defined in the invention, the substrate film in the thermal transfer sheet may be any conventional known one satisfying the desired heat resistance and strength. For the substrate film, for example, preferred are thin paper such as glassine paper, condenser paper, puffin paper, etc.; heat-resistant polyesters such as polyethylene terephthalate, polyethylene naphthalate, polybutylene terephthalate, polyphenylene sulfide, polyether ketone, polyether sulfone, etc.; stretched or unstretched films of plastics such as polypropylene, polycarbonate, cellulose acetate, polyethylene derivative, polyvinyl chloride, polyvinylidene chloride, polystyrene, polyamide, polyimide, polymethylpentene, ionomer, etc.; laminates of those materials, etc. Of those, more preferred are polyester films, and even more preferred are stretched polyester films. The thickness of the substrate film may be suitably defined in accordance with the material of the film so that the film could have intended strength and heat resistance. Preferably, the thickness is from 1 to 30 μm or so, more preferably from 1 to 20 μm or so, even more preferably from 3 to 10 μm or so.

### <Dye Layer>

The dye layer to be provided on one side of the thermal transfer sheet of the invention contains a thermotransferable dye and a binder; and the dye layer contains at least one dye of the following formula (1), and at least 50% by mass of the binder in the dye layer is a carboxylic acid-modified polyvinyl acetal resin.

### (Dye)

The thermotransferable dye of formula (1) for use in the invention is described hereinunder in more detail.

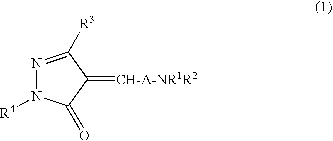

In formula (1), A represents a substituted or unsubstituted phenylene group; R¹ and R² each independently represent a hydrogen atom, a substituted or unsubstituted alkyl group, or a substituted or unsubstituted aryl group; R³ represents a substituted or unsubstituted amino group, a substituted or unsubstituted alkoxy group, or a substituted or unsubstituted aryloxy group; R⁴ represents a substituted or unsubstituted alkyl group, or a substituted or unsubstituted aryl group.

A is a substituted or unsubstituted phenylene group, preferably an unsubstituted phenylene group.

R¹ and R² each are independently a hydrogen atom, a substituted or unsubstituted alkyl group, or a substituted or unsubstituted aryl group, more preferably a substituted or unsubstituted alkyl group (preferably having from 1 to 6 carbon atoms), most preferably an ethyl group.

R³ is a substituted or unsubstituted amino group, a substituted or unsubstituted alkoxy group, or a substituted or unsubstituted aryloxy group, preferably a dialkylamino group (preferably having from 2 to 8 carbon atoms), an unsubstituted amino group, or an unsubstituted alkoxy group (preferably having from 1 to 6 carbon atoms), more preferably a dialkylamino group (preferably having from 2 to 4 carbon atoms), or an unsubstituted alkoxy group (preferably having from 1 to 4 carbon atoms), even more preferably an unsubstituted alkoxy group (preferably having from 1 to 4 carbon atoms), most preferably an ethoxy group.

R⁴ is a substituted or unsubstituted alkyl group, or a substituted or unsubstituted aryl group, preferably a substituted or unsubstituted alkyl group having from 1 to 8 carbon atoms, or a substituted or unsubstituted aryl group having from 6 to 10 carbon atoms, more preferably a substituted or unsubstituted aryl group having from 6 to 10 carbon atoms, even more preferably a substituted or unsubstituted phenyl group, most preferably an unsubstituted phenyl group.

Specific compound examples of the dye of formula (1) are shown below, by which, however, the invention should not be limitatively interpreted.

TABLE 1
Dye of Formula (1)

| Compound | | | | | |
|---|---|---|---|---|---|
| Example | A | R¹ | R² | R³ | R⁴ |
| 1-1 | Ph | ethyl | ethyl | ethoxy | phenyl |
| 1-2 | Ph | ethyl | ethyl | dimethylamino | phenyl |
| 1-3 | Ph | n-propyl | n-propyl | ethoxy | phenyl |
| 1-4 | Ph | n-butyl | n-butyl | ethoxy | phenyl |

(Ph: 1,4-phenylene)

Of the dyes of formula (1), those unavailable as commercial products can be produced through ordinary dehydrating condensation of a pyrazolone derivative and an aminobenzaldehyde derivative.

In the invention, the dye layer may contain any other dye than the dye of formula (1), as combined. Not specifically defined, the additional dye may be any one capable of diffusing under heat, capable of being incorporated into the thermal transfer sheet and capable of being transferred under heat from the thermal transfer sheet onto an image-receiving sheet; and the additional dye may be any ordinary dye heretofore generally used in thermal transfer sheets or any known dye.

The additional dye preferred for combination use with the dye of formula (1) includes, for example, methine dyes such as diarylmethane dyes, triarylmethane dyes, thiazole dyes, merocyanine dyes, etc.; azomethine dyes such as typically indaniline, acetophenonazomethine, pyrazoloazomethine, imidazolazomethine, imidazazomethine, pyridonazomethine; xanthene dyes; oxazine dyes; cyanomethylene dyes such as typically dicyanostyrene, tricyanostyrene; thiazine dyes; azine dyes; acridine dyes; benzenazo dyes; azo dyes such as pyridonazo dyes, thiophenazo dyes, isothiazolazo dyes, pyrrolazo dyes, pyralazo dyes, imidazolazo dyes, thiadiazolazo dyes, triazolazo dyes, disazo dyes; spiropyrane dyes; indolinospiropyrane dyes; fluoran dyes; rhodamine lactam dyes; naphthoquinone dyes; anthraquinone dyes; quinophthalone dyes; etc.

As specific examples of the additional dye to be combined with the dye of formula (1), yellow dyes include Disperse Yellow 231, Disperse Yellow 201, Solvent Yellow 93, etc., and of those, preferred is Solvent Yellow 93; magenta dyes include Disperse Violet 26, Disperse Red 60, Solvent red 19, etc., and of those, preferred are Disperse Violet 26 and Disperse Red 60; and cyan dyes include Solvent Blue 63, Solvent Blue 36, Disperse Blue 354, Disperse Blue 35, etc., and of those, preferred is Solvent Blue 63. Needless-to-say, any other suitable dyes than these dyes exemplified herein are also usable in the invention.

Dyes of different colors as above may be combined in any desired manner for use herein. For example, a black dye may be formed by combination of different dyes.

In case where the dye of formulae (1) is in the yellow dye layer to be mentioned below, its content is preferably from 10 to 90% by mass of all the dyes in the yellow dye layer, more preferably from 20 to 80% by mass.

In case where the dye of formulae (1) is in the magenta or cyan dye layer to be mentioned below, its content is preferably from 0.1 to 5% by mass of all the dyes in the dye layer, more preferably from 0.5 to 2% by mass. In case where the content of the dye of formula (1) in the magenta or cyan dye layer is less than 5% by mass, then the color reproducibility hardly lowers.

### (Binder in Dye Layer)

In the thermal transfer sheet of the invention, the dye of formula (1) must be in the dye layer formed on a substrate film, in which the dye is dispersed in a binder (resin binder). A carboxylic acid-modified polyvinyl acetal resin is used as the binder in the dye layer in the invention, and this is described in detail hereinunder.

In the invention, the carboxylic acid-modified polyvinyl acetal is a polyvinyl acetal in which a part or all of —OH groups are esterified with a compound having a carboxyl group. The carboxylic acid-modified polyvinyl acetal is a compound having an acetalized structure through reaction of at least a part of —OH groups derived from polyvinyl alcohol with aldehyde or the like.

The acetal structure in the carboxylic acid-modified polyvinyl acetal may be one derived from a single aldehyde or one derived from plural aldehydes.

The carboxylic acid-modified polyvinyl acetal preferred for use in the invention includes, for example, those of the following formula (2):

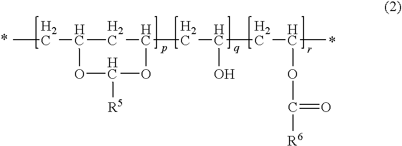

wherein R⁵ represents a substituted or unsubstituted alkyl group; R⁶ represents a hydrogen atom or a substituted or unsubstituted hydrocarbon group; p indicates the molar ratio of the acetal structure containing an acetalized —OH group; q indicates the molar ratio of the vinyl alcohol structure; r indicates the molar ratio of the structure containing a carboxylic acid-modified —OH group; p and r each are from more than 0% to less than 100%; q is from 0% to less than 100%; and p+q+r=100%.

R⁵ is a substituted or unsubstituted alkyl group, preferably an unsubstituted alkyl group having from 1 to 10 carbon atoms, more preferably an alkyl group having from 1 to 3 carbon atoms.

R⁵'s in the individual acetal structures may be the same or different; but preferably, at least 50 mol % of the acetal structures in the carboxylic acid-modified polyvinyl acetal resin are acetacetal structures from the viewpoint of increasing the print density and enhancing the low-temperature runnability of the sheet. More preferably, at least 65%, even more preferably at least 80% of the acetal structures in the carboxylic acid-modified polyvinyl acetal resin are acetacetal structures.

R⁶ is a hydrogen atom or a substituted or unsubstituted hydrocarbon group, preferably a substituted hydrocarbon group having from 1 to 20 carbon atoms, more preferably a hydrocarbon group having from 1 to 20 carbon atoms and substituted with a carboxyl group.

p is preferably from more than 0% to 95%, more preferably from 70 to 90%.

q is preferably from more than 0% to 15%, even more preferably from 1 to 10%.

r is preferably from 5 to 30%, even more preferably from 10 to 20%.

The constitution of the recurring units in the polyvinyl acetal resin is not specifically defined, and the resin may be any of a random copolymer or a block copolymer.

The polyvinyl acetal resin may be a copolymer containing any other component than the recurring units in the formula (2), but preferably contains only the recurring units in the formula (2).

The carboxylic acid-modified polyvinyl acetal may be produced, for example, in two stages according to a known method as mentioned below.

(1) A polyvinyl alcohol and a carboxyl group-having compounds are reacted for esterification according to a known method (for example, see “Poval” issued by the Kobunshi Kankokai). In principle, the reaction is partial as this is followed by the subsequent acetalization (2).

(2) The polymer in (1) is reacted with an aldehyde compound according to a known manner to give a desired carboxylic acid-modified polyvinyl acetal.

In the reaction (1), the carboxyl group-having compound to be reacted with a polyvinyl alcohol includes an aliphatic monocarboxylic acid such as acetic acid, propionic acid, etc.; an aliphatic dicarboxylic acid such as malonic acid, succinic acid, etc.; and an aromatic carboxylic acid such as phthalic acid, etc. Preferably, the polyvinyl alcohol is modified with a di- or more poly-carboxylic acid, and at least after the modification, the modified polyvinyl alcohol has at least one carboxyl group remaining therein except the ester bond-forming carboxylic acid. Concretely, preferred are succinic acid and phthalic acid.

In particular, in the esterification (1), preferably used is succinic anhydride or phthalic anhydride as not producing water as a side product in the esterification.

The aldehyde compound to be reacted with the polymer in the reaction (2) includes acetaldehyde, butylaldehyde, capronaldehyde, benzaldehyde, phenylacetaldehyde, anthraldehyde, p-ethylbenzaldehyde, chlorobenzaldehyde, cinnamaldehyde, etc. Of those, preferred are butylaldehyde, acetaldehyde and phenylacetaldehyde; more preferred are butylaldehyde and acetaldehyde; most preferred is acetaldehyde.

Two or more different types of the above-mentioned aldehyde compounds may be used to form two or more different types of acetal groups; however, preferably in the invention, acetacetal groups account for at least 50 mol % of the acetal moiety, even more preferably at least 80 mol %; and therefore, the amount of the aldehyde compound to be reacted in the reaction (2) is preferably so controlled that the acetal moiety satisfies the above ratio. By changing the amount of the aldehyde to be put into the reactor, the degree of acetalization can be controlled.

Concretely in the invention, the carboxylic acid-modified polyvinyl acetal can be produced according to the process mentioned below.

The carboxylic acid-modified polyvinyl alcohol produced in the esterification (1) is reacted with an aldehyde compound, using an acid catalyst, in water or in an organic solvent. The acid catalyst for acetalization includes an inorganic acid such as hydrochloric acid, sulfuric acid, phosphoric acid, etc.; acetic acid, p-toluenesulfonic acid, etc. The amount of the catalyst to be used is preferably from 0.005 to 0.2 mols relative to 1 mol of the aldehyde and/or ketone to be used in the reaction. The reaction temperature for acetalization may be from 20° C. to 100° C. or so, preferably from 40° C. to 90° C. In this stage, by changing the degree of polymerization of the commercially-available polyvinyl alcohol for use in first producing the carboxylic acid-modified polyvinyl alcohol, the molecular weight of the polyvinyl acetal to be produced finally can be controlled. Commercial products of polyvinyl alcohol having a different degree of polymerization are known, such as Poval (trade name by Kuraray) PVA110, PVA117, PVA120, PVA124, etc.

### (Constitution of Dye Layer)

In the invention, the carboxylic acid-modified polyvinyl acetal resin accounts for at least 50% by mass of the entire binder in the dye layer, preferably at least 80% by mass.

Any other resin may be combined with the carboxylic acid-modified polyvinyl acetal resin in the invention; and as the other resin, preferred are a cellulose resin and a polyvinyl acetal resin, more preferred is a polyvinyl acetal resin. As the other resin, preferred for use in the invention are a polyvinylacetacetal resin, a polyvinylbutyral resin and their copolymers; and most preferred are a polyvinylacetacetal resin and a polyvinylacetacetal/polyvinylbutyral copolymer from the viewpoint of satisfying both high print density and good low-temperature runnability.

In the thermal transfer sheet of the invention, the binder in the dye layer preferably contains a resin having both an acetacetal structure and an acetobutyral structure from the viewpoint of enhancing the low-temperature runnability of the sheet.

In the dye layer, the ratio by mass of the dye of formula (1) to the binder, or that is, dye/binder is preferably from 0.3 to 3.0, more preferably from 1.0 to 2.5, most preferably from 1.4 to 2.5.

Regarding the dye layer constitution, yellow, magenta and cyan dye layers and optionally a black dye layer are separately and repeatedly formed by coating on one and the same substrate according to a frame sequential method. In one example, yellow, magenta and cyan dye layers are separately and repeatedly formed by coating on one substrate film in the long axis direction in accordance with the area of the recording surface of the thermal transfer image-receiving sheet to be combined with the thermal transfer sheet, according to a frame sequential method. Applied to these three layers, preferably, a black layer, a transferable protective layer or both is provided.

In this embodiment, preferably, a mark may be put to the thermal transfer sheet for the purpose of transmitting the starting point of each color layer to printer. In the embodiment of producing a thermal transfer sheet by separately and repeatedly forming the individual layers by coating on a substrate according to a frame sequential method, the thermal transfer sheet produced enables image formation by dye transfer and protective layer lamination on the formed image all at once.

However, the invention is not limited to the mode of formation of dye layers in the manner as above. A sublimable thermal transfer dye layer and a thermofusible transfer dye layer may be provided on one substrate, or any other dye layers than yellow, magenta, cyan and black layers may be provided; and any such modification is applicable to the invention. Regarding the form thereof, the thermal transfer sheet may be a long strip-like one, or may be in the form of sheets. The invention is especially favorable to the embodiment where the thermal transfer sheets before use are stored as overlaid one upon another.

The dye layer may have a single-layer structure or a multilayer structure; and when having a multilayer structure, the compositions of the constitutive layers to form the dye layer may be the same or different.

### (Method of Forming Dye Layer)

In producing the thermal transfer sheet of the invention, preferably, the dye layer is formed according to an ordinary method of roll coating, bar coating, gravure coating, gravure reverse coating or the like. The coating amount of the dye layer is preferably from 0.1 to 2.0 g/m² (as solid content—unless otherwise specifically indicated, the coating amount in the invention is in terms of the solid content thereof), more preferably from 0.2 to 1.2 g/m². Preferably, the thickness of the dye layer is from 0.1 to 2.0 more preferably from 0.2 to 1.2 μm.

The dye layer coating liquid for forming the dye layer contains at least the above-mentioned thermotransferable dye and the above-mentioned binder, and may optionally contain an organic fine powder or an inorganic fine powder, a wax, a silicone resin, a fluorine-containing organic compound or the like in a preferred embodiment of the invention.

### <Heat-Resistant Lubricant Layer>

Preferably, the thermal transfer sheet of the invention has a heat-resistant lubricant layer (preferably contains a lubricant and a binder) on the other side (back) of the substrate film not having the dye layer, or that is, the side thereof to be in contact with a thermal head or the like. In a case of a protective layer transfer sheet, also preferably, such a heat-resistant lubricant layer is provided on the side (back) of the substrate opposite to the side thereof coated with a transferable protective layer, or that is, the side thereof to be in contact with a thermal head or the like.

When the thermal transfer sheet is heated in such a condition that the back of the substrate sheet thereof is in direct contact with a heating device such as thermal head or the like, then there may occur thermal fusion. In addition, the friction between the two is great and the thermal transfer sheet is difficult to smoothly carry during printing.

The heat-resistant lubricant layer is provided so that the thermal transfer sheet can resist the heat energy from thermal head, and it prevents thermal fusion and enables smooth running of the sheet. With the recent tendency toward high-speed printers in the art, the heat energy from thermal head is increasing and the necessity for the heat-resistant lubricant layer is increasing.

Preferably, the heat-resistant lubricant layer is formed of a coating liquid prepared by adding a lubricant, a release agent, a surfactant, inorganic particles, organic particles, pigment or the like to a binder. An interlayer may be provided between the heat-resistant lubricant layer and the support sheet, and a layer comprising inorganic fine particles, and a water-soluble resin or an emulsifiable hydrophilic resin is disclosed.

As the binder for the heat-resistant lubricant layer, usable is any known resin having high heat resistance. Its examples include cellulose resins such as ethyl cellulose, hydroxycellulose, hydroxypropyl cellulose, methyl cellulose, cellulose acetate, cellulose acetate butyrate, cellulose acetate propionate, nitrocellulose, etc.; vinyl resins such as polyvinyl alcohol, polyvinyl acetate, polyvinyl butyral, polyvinyl acetal, polyvinyl acetacetal resin, vinyl chloride-vinyl acetate copolymer, polyvinylpyrrolidone, etc.; acrylic resins such as polymethyl methacrylate, polyethyl acrylate, polyacrylamide, acrylonitrile-styrene copolymer, etc.; polyamide resins, polyimide resins, polyamidimide resins, polyvinyltoluene resins, chromanindene resins, polyester resins, polyurethane resins, polyether resins, polybutadiene resins, polycarbonate resins, chlorinated polyolefin resins, fluororesins, epoxy resins, phenolic resins, silicone resins, silicone-modified or fluorine-modified urethanes and other natural or synthetic resins. These may be used either singly or as combined.

For increasing the heat resistance of the heat-resistance lubricant layer, there is known a technique of crosslinking the resin through irradiation with UV rays or electron beams. Using a crosslinking agent, the resin may be crosslinked by heating. In this stage, a catalyst may be added. As the crosslinking agent, known are polyisocyanate, etc. For this, suitable is a resin having a hydroxyl group-type functional group. JP-A 62-259889 discloses formation of a heat-resistant lubricant layer by adding a filler such as an alkali metal salt or an alkaline earth metal salt of a phosphate ester, calcium carbonate or the like to a reaction product of a polyvinyl butyral and an isocyanate compound. JP-A 6-99671 discloses production of a polymer compound for forming a heat-resistant lubricant layer, through reaction of a silicone compound having an amino group and an isocyanate compound having at least 2 isocyanate groups in one molecule. In the invention, these are preferably employed.

An additive such as lubricant, plasticizer, stabilizer, filler, filler for removal of head deposit or the like may be incorporated in the heat-resistant lubricant layer.

The lubricant includes a solid lubricant comprising an inorganic compound, for example, a fluoride such as calcium fluoride, barium fluoride, graphite fluoride, etc.; a sulfide such as molybdenum disulfide, tungsten disulfide, iron sulfide, etc.; an oxide such as lead oxide, alumina, molybdenum oxide, etc.; graphite, mica, boron nitride, clays (talc, acid clay, etc.), etc.; as well as organic resins such as fluororesins, silicone resins, etc.; silicone oil; metal soaps such as metal stearates, etc.; waxes such as polyethylene wax, paraffin wax, etc.; surfactants such as anionic surfactants, cationic surfactants, ampholytic surfactants, nonionic surfactants, fluorine-containing surfactants, etc.

There are known a method of using a phosphate surfactant such as zinc salts of alkylphosphoric acid monoesters, alkylphosphoric acid diesters or the like or using a neutralized phosphate surfactant; and a method of using a neutralizing agent such as magnesium hydroxide, etc. Preferably, the lubricant for use in the invention contains such a phosphate.

Other additives to the lubricant layer include higher fatty acid alcohols, organopolysiloxanes, organic carboxylic acids and their derivatives, and fine particles of an inorganic compound such as talc, silica, etc.

Of those, inorganic particles are more preferred.

Inorganic particles are described in detail. The Mohs hardness of the inorganic particles is preferably from 3 to 7, more preferably from 3 to 6, even more preferably from 3.5 to 5.5. When the Mohs hardness is less than 3, then the thermal transfer sheet could not be prevented from being deformed during high-speed printing; and when more than 7, the thermal printer head may be damaged.

Known inorganic particles having a Mohs hardness of from 3 to 7 can be used, including, for example, calcium carbonate (Mohs hardness, 3), dolomite (MgCa(CO₃)₂) (Mohs hardness, 3.5 to 4), magnesium oxide (Mohs hardness, 4), magnesium carbonate (Mohs hardness, 3.5 to 4.5) and silica (Mohs hardness, 7). Of those, preferred are magnesium oxide and magnesium carbonate, and more preferred is magnesium oxide.

Preferably, the mean particle size of the inorganic particles to be in the heat-resistant lubricant layer is from 0.3 μm to 5 μm.

In the invention, when the mean particle size is less than 0.3 μm, then the thermal transfer sheet could not be prevented from being deformed during high-speed printing, and deposits to the thermal printer head can not be reduced; and when more than 5.0 μm, then the thermal transfer sheet may be rather deformed more during high-speed printing and in addition, the thermal printer head may be more scratched and damaged. When the thermal printer head is scratched and damaged, it means that the insulating layer to protect the electrode heat-generating part of the surface of the thermal printer head is scratched and damaged and the life of the thermal printer head is thereby shortened. The mean particle size is preferably from 0.3 μm to 4.5 μm, more preferably from 0.4 μm to 4 μm. The mean particle size is determined according to a laser diffraction scattering method. The spatial distribution of the diffraction scattering light intensity in irradiation of particles with light varies depending on the particle size, and therefore, when the spatial distribution of the diffraction scattering light intensity is measured and analyzed, then the particle size distribution can be determined. The method is established as laser diffractiometry. For the measurement, usable are commercial systems such as Shimadzu's SALD Series, Horiba's LA Series, etc.

Regarding the shape of the inorganic particles, the ratio of the maximum width to the sphere-corresponding diameter thereof is preferably from 1.5 to 50. When the ratio is less than 1.5, then the particles are almost ineffective for removing the deposits from thermal printer head, and they may rather damage thermal printer head. When the ratio is more than 50, for example, when needle-like inorganic particles having a diameter of 0.12 μm have a length of 88 μm, the ratio is about 70; and the inorganic particles of the type are readily broken by external stress given thereto and they could hardly keep their shape as such in the heat-resistant lubricant layer.

The ratio of the maximum width to the sphere-corresponding diameter of the inorganic particles may be determined with a scanning electron microscope (SEM). The concrete process is as mentioned below.

The inorganic particles are analyzed at different angles with SEM to thereby determine the shape, the length and the thickness thereof.

From the found data of the shape and the size, the volume of the particle is computed, and the sphere-corresponding diameter thereof is computed. The sphere-corresponding diameter means the diameter of the sphere having the same volume as that of computed particle volume. From the found data of the length and the thickness, the maximum width of the particle is computed. The maximum width of the particle means the largest one of the lengths between two points on the surface of the particle; and in case where the inorganic particle is columnar, the maximum width corresponds to the height of the column, in case where the inorganic particle is a needle-like one, the maximum width corresponds to the length of the needle, and in case where the inorganic particle is tabular, the maximum width corresponds to the maximum width of the main plane.

Thus measured, the maximum width of each particle is divided by the sphere-corresponding diameter to compute the ratio. In case where the shape of the particle is spherical, the maximum width is equal to the sphere-corresponding diameter, and the ratio is 1; in case where the shape of the particle is cubit, the ratio is about 1.4; and when the shape of the particle deviates more from a sphere, the ratio becomes larger.

In case where the sphere contains a void inside it, the particle volume could not be accurately computed; and in this case, the data are computed on the presumption that the particle has no void.

The ratio of the maximum width to the sphere-corresponding diameter of the individual particles to be in the heat-resistant lubricant layer varies individually. Preferably, at least 50% by mass, more preferably at least 80% by mass, most preferably at least 90% by mass of all the inorganic particles having a Mohs hardness of from 3 to 7 in the heat-resistant lubricant layer have the ratio falling within a range of from 1.5 to 50 on average.

More preferably, the ratio is from 1.8 to 45, even more preferably from 2 to 40.

The heat-resistant lubricant layer may be formed of a coating liquid prepared by adding the additives to a binder and dissolving or dispersing in a solvent, according to a conventional known coating method of gravure coating, roll coating, blade coating, wire bar coating or the like. Preferably, the thickness of the film is from 0.1 to 10 μm or so, more preferably from 0.5 to 5 μm or so.

### <Dye Barrier Layer>

The thermal transfer sheet of the invention may have a dye barrier layer provided between the dye layer and the substrate film.

### <Easy-Adhesion Layer>

The thermal transfer sheet of the invention may have an easy-adhesion layer formed by coating on the substrate film. Examples of the resin for use in the easy-adhesion layer include vinyl resins such as polyester resin, polyacrylate resin, polyvinyl acetate resin, polyvinyl chloride resin, polyvinyl alcohol resin; polyvinylacetal resins such as polyvinylacetacetal, polyvinylbutyral, etc.; polyether resins, polyurethane resins, styrene acrylate resins, polyacrylamide resins, polyamide resins, polystyrene resins, polyethylene resins, polypropylene resins, etc.

In case where an easy-adhesion layer is not provided on the sheet, the surface of the substrate film may be processed for easy adhesion for the purpose of enhancing the wettability thereof with coating liquid and for enhancing the adhesiveness of the film. For the treatment, employable are various known resin surface modification techniques of corona discharge treatment, flame treatment, ozone treatment, UV treatment, radiation treatment, surface roughening treatment, chemical treatment, vacuum plasma treatment, atmospheric pressure plasma treatment, primer treatment, grafting treatment, etc.

When the substrate film is formed through melt extrusion, the unstretched film may be coated and then stretched.

Two or more treatments mentioned above may be combined.

### <Transferable Protective Layer Laminate>

In the invention, it is also desirable to provide a transferable protective laminate on the thermal transfer sheet according to a frame sequential method. The transferable protective layer laminate forms a protective layer of a transparent resin through thermal transfer onto the thermal-transferred image, thereby covering and protecting the image, and this is for enhancing the durability such as the rubbing resistance, the lightfastness and the weather resistance of the image. In case where the transferred image is kept exposed on the surface of the image-receiving sheet and in case where the image durability such as the lightfastness, the rubbing resistance and the chemical resistance of the image is insufficient, the protective layer is effective.

The transferable protective layer laminate comprises a release layer, a protective layer and an adhesive layer formed on a substrate film in that order from the side of the substrate film. The protective layer may be composed of plural layers. In case where the protective layer has the other functions of the other layers, then the release layer and the adhesive layer may be omitted. An easy-adhesion layer may be provided on the substrate film.

### (Transferable Protective Layer)

The resin to form the transferable protective layer is preferably a resin excellent in rubbing resistance, chemical resistance, transparency and hardness, including, for example, polyester resins, acrylic resins, polystyrene resins, polyurethane resins, acrylic urethane resins, silicone-modified resins of these resins, UV-blocking resins, mixtures of these resins, ionizing radiation-curable resins, UV-curable resins, etc. Above all, preferred are polyester resins, and acrylic resins.

The resins may be crosslinked with various crosslinking agents.

### (Resin for Transferable Protective Layer)

The acrylic resin of the invention is a conventional known polymer comprising at least one monomer selected from acrylate monomers and methacrylate monomers, which may be copolymerized with styrene, acrylonitrile or the like except the acrylic monomer. Methyl methacrylate is a preferred monomer, and its content in the polymer may be at least 50% by mass.

Preferably, the acrylic resin has a molecular weight of from 20,000 to 100,000.

The polyester resin of the invention may be a conventional known saturated polyester resin. Preferably, the polyester resin has a glass transition temperature of from 50 to 120° C., and a molecular weight of from 2,000 to 40,000. More preferably, the molecular weight of the polyester resin is from 4,000 to 20,000, since the transferability of the transfer foil is bettered in transferring the protective layer.

### (UV Absorbent)

In the invention, preferably, the protective layer, the adhesive layer or both contain a UV absorbent. As the UV absorbent, any conventional known inorganic UV absorbent or organic UV absorbent can be used. The organic UV absorbent includes non-reactive UV absorbents such as salicylates, benzophenones, benzotriazoles, triazines, substituted acrylonitriles, hindered amines, etc.; and those prepared by introducing an addition-polymerizing double bond such as a vinyl group, an acryloyl group, a methacryloyl group or the like, or an alcoholic hydroxyl group, an amino group, a carboxyl group, an epoxy group, an isocyanate group or the like into those non-reactive UV absorbents followed by copolymerizing or grafting thermoplastic resins such as acrylic resins or the like with them. A method is disclosed, comprising dissolving an UV absorbent in a monomer or oligomer of resin followed by polymerizing the monomer or the oligomer (JP-A 2006-21333); and the thus-obtained UV-blocking resin may also be used here. In this case, the UV absorbent may be a non-reactive one.

Of those UV absorbents, especially preferred are benzophenones, benzotriazoles and triazines. Preferably, these UV absorbents are combined in accordance with the characteristics of the dye for use in image formation, in such a manner that the resulting combination can cover the effective UV absorption wavelength range. For non-reactive UV absorbents, preferably, a plurality of non-reactive UV absorbents each having a different structure are combined so that any UV absorbent does not precipitate out from the mixture. Commercial products of UV absorbents are available, including, for example, Tinuvin P (by Ciba-Geigy), JF-77 (by Johoku Chemical), Seesorb 701 (by Shiraishi Calcium), Sumisorb 200 (by Sumitomo Chemical), Biosorb 520 (by Kyodo Chemical Industry), Adekastab LA-32 (by Asahi Denka) (all trade names), etc.

### (Formation of Transferable Protective Layer)

The method for forming the protective layer depends on the type of the resin to be used. In general, the protective layer may be formed in the same manner as that for the dye layer mentioned above, and its thickness is preferably from 0.5 to 10 μm.

### (Release Layer)

In case where the transferable protective layer is hardly peeled away from the substrate film in thermal transfer, a release layer may be formed between the substrate film and the protective layer. A peeling layer may be formed between the transferable protective layer and the release layer. The release layer may be formed, for example, by coating with a coating liquid that contains at least one of wax, silicone wax, silicone resin, fluororesin, acrylic resin, polyvinyl alcohol resin, cellulose derivative resin, urethane resin, vinyl acetate resin, acryl vinyl ether resin, maleic anhydride resin and copolymer of those resins, according to a conventional known method of gravure coating, gravure reverse coating or the like, followed by drying it. Of the above-mentioned resins, preferred are acrylic resins formed by homopolymerization of acrylic acid, methacrylic acid or the like monomer alone or by copolymerization thereof with any other monomer, or cellulose derivative resins, as they are excellent in the adhesiveness to the substrate film and in the peelability from the protective layer.

The layer may be crosslinked with various crosslinking agents; and ionizing radiation-curable resins and UV-curable resins may also be used for the layer.

The release layer may be one that is transferred onto a transfer object through thermal transfer, or one that remains on the side of the substrate film, or one that undergoes cohesive failure, and any of these may be suitably used herein. As one preferred embodiment, the release layer is non-transferable, and remains on the side of the substrate film through thermal transfer so that the interface between the release layer and the transferable protective layer could still serve as the surface of the protective layer after thermal transfer, from the viewpoint of the surface glossiness and the transfer stability of the protective layer. The release layer may be formed according to a conventional known coating method, and its thickness is preferably from 0.5 to 5 μm or so in dry.

### (Adhesive Layer)

An adhesive layer may be provided as the outermost layer of the transferable protective layer laminate, or that is, as the outermost surface of the protective layer. Accordingly, the adhesiveness of the protective layer to the transfer subject may be bettered.

### [Thermal Transfer Image-Receiving Sheet]

Next described in detail is a thermal transfer image-receiving sheet (which may be referred to as image-receiving sheet) to be used as combined with the thermal transfer sheet of the invention for producing thermal transfer prints.

The thermal transfer image-receiving sheet has at least one receiving layer containing a thermoplastic dye-receiving polymer on a support. The receiving layer may contain a UV absorbent, a release agent, a lubricant, an antioxidant, a preservative, a surfactant, and other additives. Interlayers such as a heat-insulating layer (porous layer), a gloss-regulating layer, a white background-regulating layer, an antistatic layer, an adhesive layer, a primer layer and the like may be formed between the support and the receiving layer. Preferably, at least one heat-insulating layer is provided between the support and the receiving layer.

Preferably, the receiving layer and the interlayer are formed by a simultaneous multilayer coating method, and if desired, plural interlayers may be provided.

A curling preventing layer, a writing layer and an antistatic layer may be formed on the back of the support. For forming such coating layers on the back of the support, employable is any ordinary method of roll coating, a bar coating, a gravure coating, a gravure reverse coating or the like.

Preferably, a dye-fixable polymer latex is used in the receiving layer in the thermal transfer image-receiving sheet. One or more polymer latexes may be used either singly or as combined.

The polymer latex is generally a dispersion of fine particles of a thermoplastic resin dispersed in a water-soluble dispersant. Examples of the thermoplastic resin for use for the polymer latex in the invention include polycarbonate, polyester, polyacrylate, vinyl chloride copolymer, polyurethane, styrene-acrylonitrile copolymer, polycaprolactone, etc.

Of those, preferred are polycarbonate, polyester and vinyl chloride copolymer; and more preferred are polyester and vinyl chloride copolymer.

The polyester is obtained through condensation of a dicarboxylic acid derivative and a diol compound, and may have an aromatic ring or a saturated hydrocarbon ring, and may have a water-soluble group for imparting dispersibility to the polyester.

The vinyl chloride copolymer includes vinyl chloride-vinyl acetate copolymer, vinyl chloride-acrylate copolymer, vinyl chloride-methacrylate copolymer, vinyl chloride-vinyl acetate-acrylate copolymer, vinyl chloride-acrylate-ethylene copolymer, etc. The copolymer may be a binary copolymer or a ternary or more polynary copolymer, in which the monomers may be distributed irregularly or may be block-copolymerized.

An auxiliary monomer component such as vinyl alcohol derivative, maleic acid derivative, vinyl ether derivative or the like may be added to the copolymer. Preferably, the vinyl chloride component accounts for at least 50% by mass of the copolymer, and the auxiliary monomer component such as maleic acid derivative, vinyl ether derivative or the like accounts for at most 10% by mass of the copolymer.

One or more polymer latexes may be used either singly or as combined. The polymer latex may have a uniform structure, or may be a core/shell latex. In the latter case, the resins constituting the core and the shell may have a different glass transition temperature.

The glass transition temperature (Tg) of the polymer latex is preferably from 20° C. to 90° C., more preferably from 25° C. to 80° C.

Commercial products of acrylate latex are available, for example, Nippon Zeon's Nipol LX814 (Tg 25° C.), Nipol LX857X2 (Tg 43° C.) (both trade names), etc.

Commercial products of polyester latex are available, for example, Toyobo's Vylonal MD-1100 (Tg 40° C.), Vylonal MD-1400

(Tg 20° C.), Vylonal MD-1480 (Tg 20° C.), MD-1985 (Tg 20° C.) (all trade names), etc.

Commercial products of vinyl chloride copolymer are available, for example, Nisshin Chemical Industry's Vinybran 276 (Tg 33° C.), Vinybran 609 (Tg 48° C.), Sumika Chemtex's Sumielite 1320 (Tg 30° C.), Sumielite 1210 (Tg 20° C.) (all trade names), etc.

Regarding the amount of the polymer latex to be added to the receiving layer, preferably, the solid content of the polymer latex is from 50 to 98% by mass of all the polymers in the layer, more preferably from 70 to 95% by mass. The mean particle size of the polymer latex is preferably from 1 to 50000 nm, more preferably 5 to 1000 nm.

The heat-insulating layer preferably contains a hollow polymer.

The hollow polymer in the invention means polymer particles having a hollow inside the particles. The hollow particles are preferably in the form of aqueous dispersion, including, for example, 1) non-foaming hollow polymer particles of such that a dispersant such as water is inside the partitioning walls formed of polystyrene, acrylic resin, styrene-acrylic resin or the like, and after coating and drying, the dispersant water inside the particles is evaporated away from the particles to give hollow particles; 2) foaming microballoons of such that a low-boiling-point liquid such as butane, pentane or the like is enveloped with a resin comprising any of polyvinylidene chloride, polyacrylonitrile, polyacrylic acid, polyacrylate, or their mixture or polymer, and after coating, the low-boiling-point liquid inside the particles is expanded to give a hollow space inside the foamed particles; 3) microballoons prepared by previously heating and foaming the above 2) to be hollow particles; etc.

Of those, the hollow particles in the invention are preferably the above-mentioned 1) non-foaming hollow particles, and if desired, two or more different types of those hollow particles may be mixed for use herein. Their concrete examples are Rohm & Haas' Rohpake HP-1055, JSR's SX866(B), Nippon Zeon's Nipol MH5055 (all trade names).

Preferably, the mean particle size of the hollow particles is from 0.1 to 5.0 μm, more preferably from 0.2 to 3.0 μm, even more preferably from 0.4 to 1.4 μm.

Also preferably, the hollow particles have a degree of hollowness of from 20 to 70% or so, more preferably from 30 to 60%.

The size of the hollow polymer particles may be computed as follows: Using a transmission electronic microscope, the circle-equivalent outer diameter of each particle is measured, and the data are averaged. Concretely, at least 300 hollow polymer particles are analyzed with a transmission electronic microscope, and the circle-equivalent outer diameter of each particle is measured, and the data are averaged. The degree of hollowness of the hollow polymer may be derived from the proportion of the volume of the void part in a particle to the volume of the particle.

As the polymer property thereof, the hollow polymer preferably has a glass transition temperature (Tg) of from 70° C. to 200° C., more preferably from 90° C. to 180° C. As the hollow polymer, more preferred is hollow polymer latex.

In the thermal transfer image-receiving sheet, the receiving layer and/or the heat-insulating layer may contain a water-soluble polymer. The water-soluble polymer has a solubility of at least 0.05 g in 100 g of water at 20° C., more preferably having a solubility of at least 0.1 g, even more preferably at least 0.5 g.

The water-soluble polymer usable in the thermal transfer image-receiving sheet includes carrageenans, pectin, dextrin, gelatin, casein, carboxymethyl cellulose, hydroxyethyl cellulose, hydroxypropyl cellulose, polyvinyl pyrrolidone, polyvinyl pyrrolidone copolymer, polyvinyl alcohol, polyethylene glycol, polypropylene glycol, water-soluble polyester, etc. Of those, preferred are gelatin and polyvinyl alcohol.

Gelatin having a molecular weight of from 10,000 to 1,000,000 is usable herein. Gelatin may contain an anion such as SO₄²⁻, etc., and may contain a cation such as Fe²⁺, Ca²⁺, Mg²⁺, Sn²⁺, Zn²⁺, etc. Preferably, gelatin is dissolved in water and added.

Any known crosslinking agent may be added to gelatin, for example, aldehyde-type crosslinking agent, N-methylol-type crosslinking agent, vinylsulfone-type crosslinking agent, chlorotriazine-type crosslinking agent, etc. Of those, preferred are vinylsulfone-type crosslinking agent and chlorotriazine-type crosslinking agent, and their specific examples include bisvinylsulfonyl methyl ether, N,N′-ethylene-bis(vinylsulfonylacetamide)ethane, 4,6-dichloro-2-hydroxy-1,3,5-triazine or its sodium salt.

Various types of polyvinyl alcohols are usable, including completely saponified polyvinyl alcohols, partially saponified polyvinyl alcohols, modified polyvinyl alcohols, etc. These polyvinyl alcohols are described in Nagano et al's “Poval” (published by Kobunshi Kanko-kai), and are usable in the invention. The viscosity of polyvinyl alcohol can be regulated and stabilized by a minor amount of a solvent or an inorganic salt added to the aqueous solution thereof, and precisely, those described in the above-mentioned reference, pp. 144-154 can be used here. As one typical example, boric acid is preferably added to polyvinyl alcohol so as to improve the quality of the coating film. Preferably, the amount of boric acid to be added is from 0.01 to 40% by mass relative to polyvinyl alcohol.

As specific examples of polyvinyl alcohol, completely saponified products include PVA-105, PVA-110, PVA-117, PVA-117H, etc.; partially saponified products include PVA-203, PVA-205, PVA-210, PVA-220, etc.; modified polyvinyl alcohols include C-118, HL-12E, KL-118, MP-203, etc. (These are all trade names by Kuraray.)

The receiving layer of the thermal transfer image-receiving sheet may contain a polymer compound having a fluorine atom-substituted aliphatic group in the side chain. In this case, the polymer compound may be the same as that of the polymer compound having a fluorine atom-substituted aliphatic group in the side chain which is in the thermal transfer sheet, or may differ from it but is within the same category as that of it; and this is a preferred embodiment of the invention. In addition, the receiving layer may contain, as a release agent, any of solid waxes such as known polyethylene wax, amide wax, etc., as well as silicone oil, phosphate compounds, fluorine-containing surfactants, silicone-type surfactants, etc.

The content of the polymer compound having a fluorine atom-substituted aliphatic group in the side chain may be from 0.01% to 20% relative to the total solid content (by mass) of the receiving layer, preferably from 0.1% to 10%, more preferably from 1% to 5%.

### [Method of Image Formation]

A method of image formation with the thermal transfer sheet of the invention is described below.

In the method of image formation, a thermal transfer image-receiving sheet and the thermal transfer sheet are put one upon another in such a manner that the receiving layer of the former can be kept in contact with the thermal transfer layer such as the dye layer of the latter, and heat energy corresponding to the image signal from a thermal head is imparted to the two from the side of the heat-resistant lubricant layer of the thermal transfer sheet for image formation.

Regarding the details of the method, for example, referred to are those of the method described in JP-A 2005-88545. In the invention, from the viewpoint of shortening the time to be taken before prints are provided to consumers, the printing time is preferably less than 15 seconds, more preferably from 3 to 12 seconds, even more preferably from 3 to 7 seconds.

For satisfying the above-mentioned printing time, the line speed in printing is preferably at most 0.73 msec/line, more preferably at most 0.65 msec/line. From the viewpoint of enhancing the transfer efficiency under high-speed processing condition, the ultimate temperature of the thermal printer head in printing is preferably from 180° C. to 450° C., more preferably from 200° C. to 450° C., even more preferably from 350° C. to 450° C.

The invention is applicable to printers, duplicators and the like driven according to a thermal transfer recording system. As the means for imparting heat energy in thermal transfer, any known impartation means may be used. For example, while the recording time is controlled by a recording device such as a thermal printer (e.g., Hitachi's trade name, Video Printer VY-100) or the like, heat energy of from 5 to 100 mJ/mm² or so is imparted whereby the intended object can be fully attained. In the thermal transfer image-receiving sheet, the support may be suitably selected, and the sheet is applicable to various uses for thermotransferable sheet-fed or roll-shaped thermal transfer image-receiving sheets, cards, sheets for transmission manuscripts, etc.

### EXAMPLES

The invention is described more concretely with reference to the following Examples. In the following Examples, the material used, its amount and the ratio, the details of the treatment and the treatment process may be suitably modified or changed not overstepping the spirit and the scope of the invention. Accordingly, the invention should not be limitatively interpreted by the Examples mentioned below. In the following Examples, part and % are by mass, unless otherwise specifically indicated.

### Example 1

### Production of Carboxylic Acid-Modified Polyvinyl Alcohol

Poval PVA110 (Kuraray's trade name) and succinic anhydride were reacted in an N,N-dimethylformamide solution with 4-dimethylaminopyridine added thereto, thereby producing the carboxylic acid-modified polyvinyl alcohol (PVA-1) shown in Table 2 below.

TABLE 2

| | —OH Group in | Succinic Acid-Modified —OH |
|---|---|---|
| | Carboxylic | Group in Carboxylic |
| | Acid-Modified | Acid-Modified Polyvinyl |
| | Polyvinyl Alcohol | Alcohol |
| | (mol %) | (mol %) |
| PVA-1 | 85 mol % | 15 mol % |

The carboxylic acid-modified polyvinyl alcohol (PVA-1) shown in the above Table 2 was reacted with an aldehyde compound (acetaldehyde and/or butylaldehyde) in water, using an acid catalyst (35% hydrochloric acid), to produce a carboxylic acid-modified polyvinyl acetal POL-1 to POL-4 having the composition shown in Table 3 below. The structure of the carboxylic acid-modified polyvinyl acetal POL-1 to POL-4 is represented by the formula (3) given below. In formula (3), the ratio of the recurring units a to d is as follows: In POL-1, a:b:c:d=0:33.5:8:15, in POL-2, a:b:c:d=19:19:9:15, in POL-3, a:b:c:d=31:7.5:8:15, and in POL-4, a:b:c:d=39:0:7:15.

TABLE 3

| | | | | Succinic |
|---|---|---|---|---|
| | | | | Acid- |
| | Acetacetalized | Butyralized | | Modified |
| | —OH Group | —OH Group | —OH Group | —OH Group |
| POL-1 | 0 mol % | 77 mol % | 8 mol % | 15 mol % |
| POL-2 | 38 mol % | 38 mol % | 9 mol % | 15 mol % |
| POL-3 | 62 mol % | 15 mol % | 8 mol % | 15 mol % |
| POL-4 | 78 mol % | 0 mol % | 7 mol % | 15 mol % |

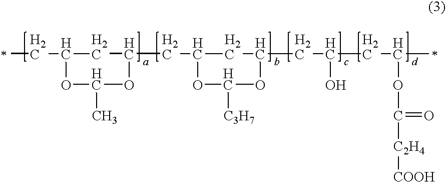

wherein a indicates the molar ratio of the acetal structure containing an acetacetalized —OH group, b indicates the molar ratio of the acetal structure containing a butyralized —OH group, c indicates the molar ratio of the vinyl alcohol structure, d indicates the molar ratio of the structure containing a succinic acid-modified —OH group.

In the carboxylic acid-modified polyvinyl acetal POL-1 to POL-4, the ratio (by mol) of the acetacetal structure to the entire acetal structure is represented by (mol % of acetacetalized —OH group)/{(mol % of acetacetalized —OH group)+(mol % of butyralized —OH group)}×100%. Specifically, the proportion of the acetacetal structure to the entire acetal structure in the carboxylic acid-modified polyvinyl acetal is 0% in POL-1, 50% in POL-2, 80.5% in POL-3, and 100% in POL-4.

### (Production of Thermal Transfer Sheet)

An easy-adhesion layer was formed on one surface of a polyester film and then stretched to prepare a substrate film having a thickness of 4.5 μm. Onto the side of the film opposite thereof having the easy-adhesion layer thereon, the heat-resistant layer coating liquid mentioned below was applied so that its coating amount as solid after dried could be 1 g/m². Using the coating liquids mentioned below, a dye layer and a transferable protective layer laminate (composed of release layer, protective layer and adhesive layer) were formed on the side of the easy-adhesion layer-coated surface of the heat-resistant lubricant layer-having polyester film prepared in the manner as above, according to a frame sequential method, thereby producing a thermal transfer sheet 101. The coating amount as solid of the dye layer was 0.8 g/m². The dry coating amount of the transferable protective layer laminate was as follows: The lubricant layer was 0.2 g/m², the protective layer was 0.4 g/m², the adhesive layer was 2.0 g/m².

Immediately after coating, the sheet was dried in an oven at 100° C. for 1 minute.

### Heat-Resistant Lubricant Layer Coating Liquid:

| | |
|---|---|
| Acrylic polyol resin (Acrydic A-801, trade name by DIC) | 17.3 mas. pts. |
| Zinc stearate (SZ-2000, trade name by Sakai | 0.26 mas. pts. |
| Chemical Industry) | |
| Phosphate (Phoslex A18, trade name by Sakai | 0.52 mas. pts. |
| Chemical Industry) | |
| Phosphate (Prisurf A217, trade name by Daiichi Kogyo | 3.59 mas. pts. |
| Seiyaku) | |
| Talc (Microace L-1, trade name by Nippon Talc) | 0.52 mas. pts. |
| Magnesium oxide (Starmag PSF, trade name by | 0.07 mas. pts. |
| Kamishima Chemical) | |
| Polyisocyanate (Burnock D-750, trade name by DIC) | 7.77 mas. pts. |
| Methyl ethyl ketone/toluene (2/1 by mass) | 70 mas. pts. |

### Dye Layer Coating Liquid:

| | | |
|---|---|---|
| Dye compound A (Compound 1-1) | 8.0 | mas. pts. |
| Dye compound B (shown below) | 1.0 | mas. pt. |
| Polyvinyl butyral resin (Denkabutyral #3000-1, trade | 6.0 | mas. pts. |
| name by Denki Kagaku Kogyo) | | |
| Fluorine-containing polymer compound (Megafac | 0.25 | mas. pts. |
| F-472SF, trade name by DIC) | | |
| Mat agent (FLO-THENE UF, trade name by | 0.15 | mas. pts. |
| Sumitomo Seiko) | | |
| Methyl ethyl ketone/toluene mixed solvent | 85 | mas. pts. |

### Release Layer Coating Liquid:

| | |
|---|---|
| Modified cellulose resin (L-30, trade name by Daicel | 5.0 mas. pts. |
| Chemical) | |
| Methyl ethyl ketone/toluene mixed solvent | 95.0 mas. pts. |
| Protective Layer Coating Liquid: | |
| Acrylic resin solution (solid content 40%) (UNO-1, trade | 90 mas. pts. |
| name by Gifu Ceramic) | |
| Methanol/isopropanol mixed solvent | 10 mas. pts. |

### Adhesive Layer Coating Liquid:

| Acrylic resin (Dianal BR-77, trade name by | 25 mas.pts. |
|---|---|
| Mitsubishi Rayon) | |
| UV absorbent UV-1 mentioned below | 0.5 mas.pts. |
| UV absorbent UV-2 mentioned below | 2 mas.pts. |
| UV absorbent UV-3 mentioned below | 0.5 mas.pts. |
| UV absorbent UV-4 mentioned below | 0.5 mas.pts. |
| PMMA fine particles (polymethyl methacrylate | 0.4 mas.pts. |
| fine particles) | |
| Methyl ethyl ketone/toluene mixed solvent | 70 mas.pts. |
| 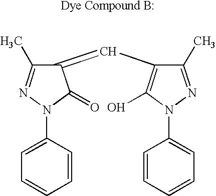 | |

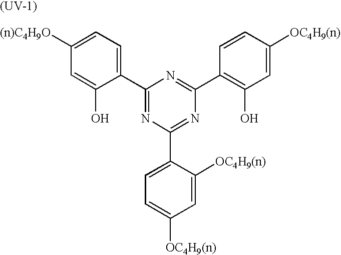

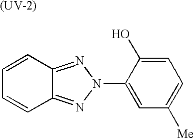

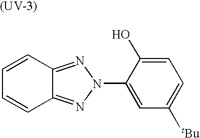

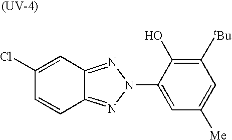

### (Production of Thermal Transfer Image-Receiving Sheet)

The surface of a paper support double-laminated with polyethylene was processed for corona discharge treatment, and then a sodium dodecylbenzenesulfonate-containing gelatin undercoat layer was formed on it. On this, a subbing layer, a heat-insulating layer, a lower receiving layer and an upper receiving layer were laminated by coating in that order from the side of the support through the simultaneous multilayer coating method illustrated in FIG. 9 in U.S. Pat. No. 2,761,791. The dry coating amount of the subbing layer was 6.2 g/m², that of the heat-insulating layer was 8.0 g/m², that of the lower receiving layer was 2.8 g/m², and that of the upper receiving was 2.3 g/m². The composition mentioned below is by mass of the solid content.

### Upper Receiving Layer:

| | |
|---|---|
| Vinyl chloride latex (Vinybran 900, trade name by | 19.0 mas. pts. |
| Nisshin Chemical Industry) | |
| Vinyl chloride latex (Vinybran 276, trade name by | 3.6 mas. pts. |
| Nisshin Chemical Industry) | |
| Gelatin (aqueous 10% solution) | 2.4 mas. pts. |
| Ester wax EW-1 mentioned below | 1.9 mas. pts. |
| Surfactant F-1 mentioned below | 0.12 mas. pts. |
| Surfactant F-2 mentioned below | 0.33 mas. pts. |

### Lower Receiving Layer:

| | |
|---|---|
| Vinyl chloride latex (Vinybran 690, trade name by | 12.0 mas. pts. |
| Nisshin Chemical Industry) | |
| Vinyl chloride latex (Vinybran 900, trade name by | 12.0 mas. pts. |
| Nisshin Chemical Industry) | |
| Gelatin (aqueous 10% solution) | 7.0 mas. pts. |
| Surfactant F-1 mentioned below | 0.04 mas. pts. |

### Heat-Insulating Layer:

| | |
|---|---|
| Hollow polymer particle latex (MH5055, trade name | 60.0 mas. pts. |
| by Nippon Zeon) | |
| Gelatin (aqueous 10% solution) | 22.0 mas. pts. |

### Subbing Layer:

| | |
|---|---|
| Polyvinyl alcohol (Poval PVA205, trade name by Kuraray) | 7.7 mas.pts. |
| Styrene butadiene rubber latex (SN-307, trade name by | 60.0 mas.pts. |
| Nippon A & L) | |
| Surfactant F-1 mentioned below | 0.03 mas.pts. |

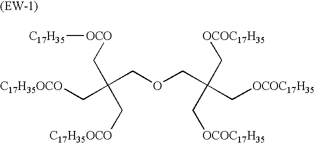

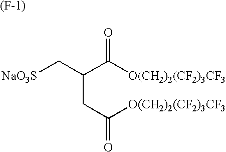

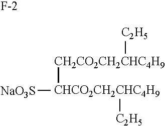

Thermal transfer sheets 102 to 110 were produced in the same manner as that for the thermal transfer sheet 101, for which, however, the dye and the binder were changed as in Table 5 shown below. The ratio by mass of the dye to the binder (dye/binder) in the thermal transfer sheets 101 to 110 was all 1.5. The dye B and the disperse yellow dye are not in the scope of the formula (1).

TABLE 4

| Thermal | | |
|---|---|---|
| Transfer | | |
| Sheet | Dye | Binder (resin) |
| 101 | Dye A 8.0 mas. pts. | Polyvinyl butyral resin |
| | Dye B 1.0 mas. pts. | (Denkabutyral #3000-1, |
| | | trade name by Denki |
| | | Kagaku Kogyo) |
| | | 6.0 mas. pts. |
| 102 | Dye A 8.0 mas. pts. | Phenoxy resin (PKHJ, |
| | Dye B 1.0 mas. pts. | trade name) |
| | | 6.0 mas. pts. |
| 103 | Dye A 8.0 mas. pts. | POL-1 6.0 mas. pts. |
| | Dye B 1.0 mas. pts. | |
| 104 | Dye A 8.0 mas. pts. | POL-2 6.0 mas. pts. |
| | Dye B 1.0 mas. pts. | |
| 105 | Dye A 8.0 mas. pts. | POL-3 6.0 mas. pts. |
| | Dye B 1.0 mas. pts. | |
| 106 | Dye A 8.0 mas. pts. | POL-4 6.0 mas. pts. |
| | Dye B 1.0 mas. pts. | |
| 107 | Dye A 8.0 mas. pts. | POL-4 4.8 mas. pts. |
| | Dye B 1.0 mas. pts. | Polyvinyl acetal resin |
| | | (Denkabutyral #5000-D, |
| | | trade name by Denki |
| | | Kagaku Kogyo) |
| | | 1.2 mas. pts. |
| 108 | Disperse Yellow 201 | Polyvinyl butyral resin |
| | 5.0 mas. pts. | (Denkabutyral #3000-1, |
| | Disperse Yellow 231 | trade name by Denki |
| | 4.0 mas. pts. | Kagaku Kogyo) |
| | | 6.0 mas. pts. |
| 109 | Disperse Yellow 201 | Phenoxy resin (PKHJ, |
| | 5.0 mas. pts. | trade name) |
| | Disperse Yellow 231 | 6.0 mas. pts. |
| | 4.0 mas. pts. | |
| 110 | Disperse Yellow 201 | POL-1 6.0 mas. pts. |
| | 5.0 mas. pts. | |
| | Disperse Yellow 231 | |
| | 4.0 mas. pts. | |

### (Pretreatment Prior to Low-Temperature Runnability Evaluation)

The thermal transfer sheet shown in Table 4 above and the thermal transfer image-receiving sheet were conditioned in an environment at 15° C./20% for 12 hours and then in an environment at 30° C./40% for 12 hours. The pretreatment was applied to all the samples repeatedly 12 cycles each. Thus pretreated, the samples were tested for evaluation.

### (Low-Temperature Print Density Evaluation)

The print density was measured with X-rite's X-rite 530LP in an environment of 15° C./20%. 30 points in every sample were analyzed, and the data were averaged to be the yellow density. The results are shown in Table 5 below.

### (Low-Temperature Runnability Evaluation)

The thermal transfer sheet and the thermal transfer image-receiving sheet that had been pretreated as above were tested in a printer, FUJIFILM's Thermal Photo Printer ASK2000 (trade name) in an environment of 15° C./20% and an environment of 30° C./40%, thereby forming an yellow solid image thereon. 50 copies were made in every sample case, and the frequency of print error was counted. An interval of 5 minutes was taken in every one printing.

The low-temperature runnability was evaluated according to the criteria mentioned below.

5: The frequency of print error was 0. The sample had extremely excellent low-temperature runnability.
4: The frequency of print error was once or twice. The sample had excellent low-temperature runnability.
3: The frequency of print error was 3 times to 5 times. The sample had good low-temperature runnability.
2: The frequency of print error was 6 times to 10 times. The sample did not have low-temperature runnability.
1: The frequency of print error was more than 10 times. The sample did not have low-temperature runnability.

The evaluation results are shown in Table 5.

TABLE 5

| Thermal | | | | |
|---|---|---|---|---|
| Transfer | Low-Temperature | | | |
| Sheet | Print | Runnability | Runnability | |
| Number | Density | 30° C./40% | 15° C./20% | Remarks |
| 101 | 1.81 | 5 | 1 | comparative |
| | | | | example |
| 102 | 1.75 | 5 | 1 | comparative |
| | | | | example |
| 103 | 1.95 | 5 | 3 | the |
| | | | | invention |
| 104 | 2.01 | 5 | 4 | the |
| | | | | invention |
| 105 | 2.06 | 5 | 5 | the |
| | | | | invention |
| 106 | 2.08 | 5 | 5 | the |
| | | | | invention |
| 107 | 2.06 | 5 | 5 | the |
| | | | | invention |
| 108 | 1.62 | 5 | 5 | comparative |
| | | | | example |
| 109 | 1.65 | 5 | 5 | comparative |
| | | | | example |
| 110 | 1.60 | 5 | 5 | comparative |
| | | | | example |

From Table 5, it is known that the thermal transfer sheets of the invention have high print density and have improved low-temperature runnability.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2009-081138, filed on Mar. 30, 2009, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A thermal transfer sheet having a dye layer that contains a thermotransferable dye and a binder on one side of a substrate film, wherein the dye layer contains at least one dye of the following formula (1), and at least 50% by mass of the binder in the dye layer is a carboxylic acid-modified polyvinyl acetal resin: 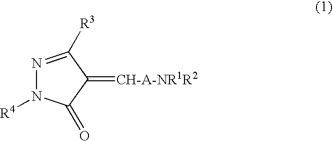
wherein A represents a substituted or unsubstituted phenylene group; R¹ and R² each independently represent a hydrogen atom, a substituted or unsubstituted alkyl group, or a substituted or unsubstituted aryl group; R³ represents a substituted or unsubstituted amino group, a substituted or unsubstituted alkoxy group, or a substituted or unsubstituted aryloxy group; R⁴ represents a substituted or unsubstituted alkyl group, or a substituted or unsubstituted aryl group.

2. The thermal transfer sheet according to claim 1, wherein at least 50 mol % of the acetal structure in the carboxylic acid-modified polyvinyl acetal resin is an acetacetal structure.

3. The thermal transfer sheet according to claim 1, wherein at least 80 mol % of the acetal structure in the carboxylic acid-modified polyvinyl acetal resin is an acetacetal structure.

4. The thermal transfer sheet according to claim 1, wherein the carboxylic acid-modified polyvinyl acetal resin is represented by the following formula (2): 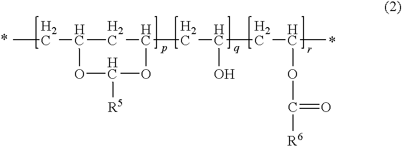
wherein R⁵ represents a substituted or unsubstituted alkyl group, R⁶ represents a hydrogen atom or a substituted or unsubstituted hydrocarbon group, p and r each independently are from more than 0% to less than 100%, q is from 0% to less than 100%, and p+q+r is 100%.

5. The thermal transfer sheet according to claim 4, wherein R⁵ in the formula (2) represents an alkyl group having from 1 to 3 carbon atoms.

6. The thermal transfer sheet according to claim 4, wherein R⁶ in the formula (2) represents a hydrocarbon group having from 1 to 20 carbon atoms and substituted with a carboxyl group.

7. The thermal transfer sheet according to claim 4, wherein, in the formula (2), p is from more than 0% to 95%, q is from more than 0% to 15%, and r is from 5 to 30%.

8. The thermal transfer sheet according to claim 4, wherein, in the formula (2), p is from 70% to 90%, q is from 1% to 10%, and r is from 10 to 20%.

9. The thermal transfer sheet according to claim 1, wherein at least 80% by mass of the binder in the dye layer is a carboxylic acid-modified polyvinyl acetal resin.

10. The thermal transfer sheet according to claim 1, wherein the dye layer further contains a cellulose resin or a polyvinyl acetal resin.

11. The thermal transfer sheet according to claim 1, wherein A in the formula (1) represents a phenylene group.

12. The thermal transfer sheet according to claim 1, wherein A in the formula (1) represents a 1,4-phenylene group.

13. The thermal transfer sheet according to claim 1, wherein R¹ and R² in the formula (1) each independently represent a substituted or unsubstituted alkyl group having from 1 to 6 carbon atoms.

14. The thermal transfer sheet according to claim 1, wherein R³ in the formula (1) represents a dialkylamino group having from 2 to 8 carbon atoms, an unsubstituted amino group, or an unsubstituted alkoxy group having from 1 to 6 carbon atoms.

15. The thermal transfer sheet according to claim 1, wherein R³ in the formula (1) represents an unsubstituted alkoxy group having from 1 to 4 carbon atoms.

16. The thermal transfer sheet according to claim 1, wherein R⁴ in the formula (1) represents a substituted or unsubstituted alkyl group having from 1 to 8 carbon atoms, or a substituted or unsubstituted aryl group having from 6 to 10 carbon atoms.

17. The thermal transfer sheet according to claim 1, wherein R⁴ in the formula (1) represents a substituted or unsubstituted phenyl group.

18. The thermal transfer sheet according to claim 1, wherein, in the formula (1), A represents a phenylene group, R¹ and R² each independently represent a substituted or unsubstituted alkyl group having from 1 to 6 carbon atoms, R³ represents a dialkylamino group having from 2 to 8 carbon atoms, an unsubstituted amino group, or an unsubstituted alkoxy group having from 1 to 6 carbon atoms, and R⁴ represents a substituted or unsubstituted alkyl group having from 1 to 8 carbon atoms, or a substituted or unsubstituted aryl group having from 6 to 10 carbon atoms.

19. The thermal transfer sheet according to claim 1, wherein, in the formula (1), A represents a phenylene group, R¹ and R² each independently represent a substituted or unsubstituted alkyl group having from 1 to 6 carbon atoms, R³ represents an unsubstituted alkoxy group having from 1 to 4 carbon atoms, and R⁴ represents a substituted or unsubstituted phenyl group.

20. The thermal transfer sheet according to claim 1, wherein the ratio by mass of the dye to the binder, dye/binder, is from 1.4 to 2.5.
